(19) United States
(12) Patent Application Publication
(10) Pub. No.: US 2020/0305534 A1
(43) Pub. Date: Oct. 1, 2020

(54) HELMET

(71) Applicant: Kuji Sports Co Ltd, Taipei (TW)

(72) Inventor: James A. Chilson, Ketchum, ID (US)

(73) Assignee: Kuji Sports Co Ltd, Taipei (TW)

(21) Appl. No.: 16/364,047

(22) Filed: Mar. 25, 2019

(51) Int. Cl. A42B 3/06; A42B 3/12; B32B 5/18; B32B 7/12; B32B 25/08; B32B 25/20

(52) U.S. Cl. CPC A42B 3/064; A42B 3/125; B32B 5/18; A42B 3/08; B32B 25/08; B32B 25/20; B32B 7/12

(57) ABSTRACT

A helmet comprises a protective shell, a first energy absorbing layer, a second energy absorbing layer and multiple displace devices. The protective shell forms an outer surface of the helmet. The first energy absorbing layer has a first outer surface and a first inner surface. The first inner surface is configured to couple the helmet to a wearer's head. The second energy absorbing layer has a second outer surface and a second inner surface. The second inner surface faces the first outer surface. The multiple displacement devices are positioned at multiple locations between the first energy absorbing layer and the second energy absorbing layer. The displacement devices allow displacement between the first and second energy absorbing layers in response to an oblique impact to the helmet.

### BACKGROUND

Helmets and other protective headgear are used in many applications, including sports, construction, mining, industry, law enforcement, military and others, to reduce injury to a wearer. Potential injury to a wearer can occur by way of contact with hard and/or sharp objects, which can be reduced by a helmet that prevents such objects from directly contacting the wearer's head. In addition, non-contact injury to the wearer, such as results from linear and/or rotational accelerations of the wearer's head and can cause brain injury, can be reduced by helmets that absorb or dissipate the energy produced during impacts, including oblique impacts.

Conventional approaches permit a first component of a helmet to move or deform relative to at least a second component to absorb or dissipate the energy. The relative movement can be designed to occur between first and second components that are arranged as inner and outer components relative to each other, such as inner and outer layers.

Currently available approaches to providing a helmet construction that address both contact and non-contact injury suffer from drawbacks, including overly complex design, increased weight, high cost, difficulty in manufacture, a negative effect on proper fitting of the helmet to the wearer's head, and compromised airflow though the helmet, to name a few.

### SUMMARY

Described below are implementations of a new helmet that addresses some of the drawbacks of conventional helmets.

According to one implementation, a helmet comprises a protective shell forming an outer surface of the helmet, a first energy absorbing layer, a second energy absorbing layer and at least one displacement device. The first energy absorbing layer has a first outer surface and a first inner surface, the first inner surface being configured to couple the helmet to a wearer's head. The second energy absorbing layer has a second outer surface and a second inner surface, the second inner surface facing the first outer surface. The at least one displacement device is positioned between the first energy absorbing layer and the second energy absorbing layer. The displacement device allowing displacement between the first and second energy absorbing layers in response to an oblique impact to the helmet.

The at least one displacement device may include a shear component. A pair of opposite surfaces of the shear component can be configured to be attached to the second inner surface of the second energy absorbing layer and the first outer surface of the first energy absorbing layer, respectively, such that the shear component undergoes internal shear to allow movement between the first and second energy absorbing layers in response to an oblique impact.

The first energy absorbing layer and the second energy absorbing layer can be separated from each other at a first location by a thickness of the shear component. The shear component at the first location can have a thickness of 1.5 to 3 mm.

The shear component can be formed of a material having a shear modulus of GPa 0.0001 to GPa 0.03. The shear component can be formed of a material having a Shore 00 durometer of 0 to 60. The shear component can comprise a silicone gel sheet material.

The shear component can be configured to provide a damped shear action exhibiting progressively greater force in shear without high rebound.

The opposite surfaces of the shear component can be bonded or adhered to the second inner surface of the second energy absorbing layer and the first outer surface of the first energy absorbing layer, respectively.

The first energy absorbing layer can be formed of a deformable material, and the second energy absorbing layer can be formed with an opening smaller than the first energy absorbing layer. The first energy absorbing layer can compressed from its relaxed state and passed through the opening to assemble the first energy absorbing layer within the second energy absorbing layer.

The second energy absorbing layer can be formed with a cavity defined to extend from the opening and shaped to accommodate the first energy absorbing layer with a clearance separating the first energy absorbing layer from the second energy absorbing layer. The first energy absorbing layer and the second energy absorbing layer can be separated by 0.25 mm to 1.5 mm at the location of the shear component.

In another implementation, the at least one displacement device comprises a first sheet having a first internal side and a first external side and a second sheet having a second internal side and a second external side, wherein the respective internal sides are positioned to face each other, and wherein the first external side is configured to be attached to the second inner surface of the second energy absorbing layer, and the second external side is configured to be attached to the first outer surface of the first energy absorbing layer. The first sheet and the second sheet can be bonded together at their respective edges. A lubricating substance can be positioned between the first and second internal sides.

At least the first internal side of the first sheet and the second internal side of the second sheet can comprise a thermoplastic urethane (TPU) material, and the lubricating substance can comprise a low friction gel.

The first external side of the first sheet and the second external side of the second sheet can be bonded or adhered to the second inner surface of the second energy absorbing layer and the first outer surface of the first energy absorbing layer, respectively.

The helmet can comprise multiple displacement devices, and the first energy absorbing layer and the second energy absorbing layer can be separated by 1 to 3 mm at least at locations of the multiple displacement devices.

The second energy absorbing layer can be formed with a first cavity defined to extend from the opening and shaped to accommodate the first energy absorbing layer with a first clearance separating the first energy absorbing layer from the second energy absorbing layer, further comprising a second cavity formed in the second absorbing layer and an external engagement section protruding from the first energy absorbing layer, wherein the external engagement section is sized to fit within the second cavity with a second clearance.

The helmet can comprise a fit system for adapting the helmet to be fitted to the wearer's head, wherein the fit system is coupled to the first energy absorbing layer.

The first and second energy absorbing layers comprise at least one of EPS, EPP, EPO, vinyl nitride, urethane foam, or a plastic material having a hollow geometry designed to produce reliable crush characteristics.

At least one of the first and second energy absorbing layers can be made of a plastic material with a hollow geometry by a 3D printing process and designed to produce reliable crush characteristics.

The first energy absorbing layer is shaped to extend over at least about 80% of an inner surface area of the helmet.

The first energy absorbing layer can comprise a notch with angled sides. The notch can be configured to allow the first absorbing layer to be compressed to a smaller size to facilitate fitting the first energy absorbing layer through the opening in the second energy absorbing layer.

According to another implementation, a helmet comprises a protective shell forming an outer surface of the helmet, a first energy absorbing layer and a second energy absorbing layer having a second outer surface and a second inner surface. The second energy absorbing layer comprises an opening and a cavity extending from the opening. The first energy absorbing layer is configurable in a compressed state to pass through the opening in the second energy absorbing layer and expand from the compressed state to a relaxed state. The first energy absorbing layer in the relaxed state is sized to fit and be movable within the cavity of the second energy absorbing layer while being retained by the opening. The first energy absorbing layer comprises a first piece nested within a second piece. The first energy absorbing layer comprises a first inner surface provided on the first piece and configured to couple the helmet to a wearer's head. The first energy absorbing layer comprises a first outer surface provided on the second piece and facing the second inner surface of the second energy absorbing layer. Multiple displacement devices are positioned at multiple locations between the first energy absorbing layer and the second energy absorbing layer, the displacement devices allowing displacement between the first and second energy absorbing layers in response to an oblique impact to the helmet.

According to another implementation, a helmet comprises a protective shell, a first energy absorbing layer, a second energy absorbing layer and multiple displacement devices. The protective shell forms an outer surface of the helmet and comprises at least one outer airflow opening. The first energy absorbing layer has a first outer surface, a first inner surface and at least one inner airflow opening. The first inner surface is configured to couple the helmet to a wearer's head. The second energy absorbing layer has a second outer surface, a second inner surface and at least one intermediate airflow opening. The second inner surface faces the first outer surface. The inner, intermediate and outer airflow openings are normally positioned in alignment with each other to provide airflow to the wearer's head. The multiple displacement devices are positioned at multiple locations between the first energy absorbing layer and the second energy absorbing layer. The displacement devices allow displacement between the first and second energy absorbing layers in response to an oblique impact to the helmet.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exploded perspective view of a first implementation a helmet.

FIGS. 2-4 are sectioned side elevation views of the helmet of FIG. 1 showing first and second energy absorbing layers in three different positions relative to each other.

FIG. 5A is a perspective view of an alternative first energy absorbing layer for the helmet of FIGS. 1-4.

FIG. 5B is a bottom plan view of the helmet of FIG. 1, also showing a fit system for the helmet.

FIG. 6 is a perspective view of a section of another implementation of the helmet.

FIG. 7 is a side elevation view of another implementation of the helmet.

FIG. 8 is a magnified view of a portion of FIG. 7.

FIGS. 9 and l0 are schematic diagrams showing a displacement device of FIGS. 7 and 8 at rest and in response to an applied force.

FIG. 11 is a schematic perspective view showing assembly of a displacement device according to another implementation.

FIGS. 12 and 13 are exploded perspective views from different angles, respectively, of another implementation of a helmet.

FIG. 14 is a bottom plan view of sectioned side elevation view of a fifth implementation of the helmet.

FIGS. 15A and 15B are explanatory graphs showing the relationship between applied force (stress) and displacement (strain) in purely elastic and viscoelastic materials, respectively.

### DETAILED DESCRIPTION

Described below are embodiments of a helmet that reduces contact and non-contact injury to a wearer's head in the event of an impact between the helmet and the ground or another object.

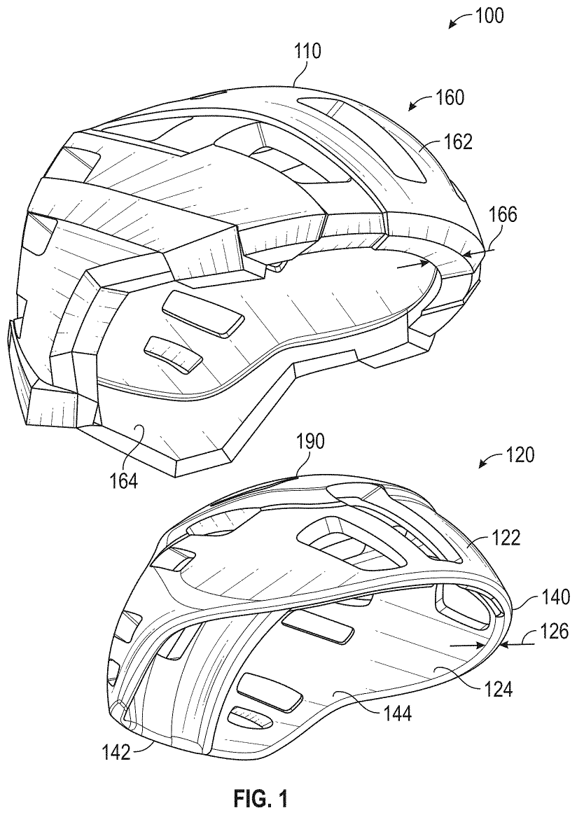

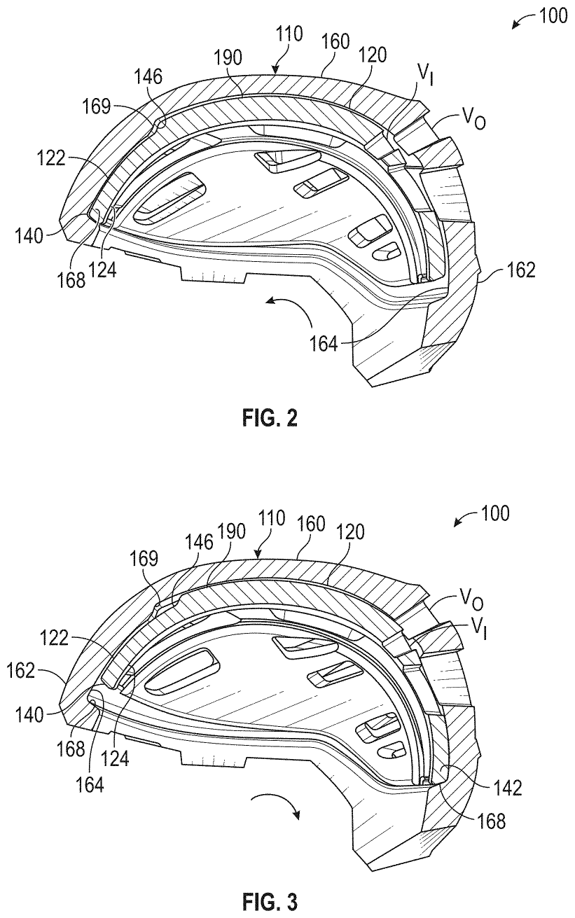

FIGS. 1-4 show a first implementation of a helmet 100 having first and second energy absorbing layers 120, 160, that fit together in a nested arrangement (FIGS. 2-4) and cooperate with each other. The helmet 100 has a protective shell 110 that forms an outer surface of the helmet 100, and the second energy absorbing layer 160 is attached to an inner side of the protective shell 110. The first energy absorbing layer 120 is sized to fit within a cavity defined by the second energy absorbing layer 160, as is described below in greater detail.

The first energy absorbing layer 120 defines a cavity shaped to fit over a portion of the wearer's head when the helmet 100 is worn. The first energy absorbing layer 120 has a first inner surface 124 that is positioned to face and/or contact the wearer's head, and an opposite first outer surface 122. A thickness 126 of the first energy absorbing layer 120, defined as the distance between the first inner surface 124 and the first outer surface 122 at any point on an axis extending from an approximate center of the wearer's head, can be varied at different locations over the first energy absorbing layer 120. As shown for the first energy absorbing layer, the helmet has a forward end 140 and an opposite rearward end 142.

The second energy absorbing layer 160 has a second inner surface 164 that faces the first outer surface 122 and an opposite second outer surface 162. In the illustrated implementation, the protective shell 110 can be attached to the second outer surface 162. A thickness 166 of the second energy absorbing layer 160, defined as the distance between the second inner surface 164 and the second outer surface 162 along the axis, can be varied at different locations on the second energy absorbing layer 160. As described and shown in more detail below, one or more displacement devices or elements can be positioned between the first outer surface 122 and the second inner surface 164 to facilitate displacement in the event of an impact, especially an oblique impact component thereof, i.e., to help control how the second energy absorbing layer 160 moves relative to the first energy absorbing layer 120.

For example, a representative displacement device 190 is shown positioned on the first outer surface 122 of the first energy absorbing layer 120 to face (and in some cases, contact) the second inner surface 164 when the helmet is assembled. Although for purposes of illustration in FIGS. 1-4 and 5A, only a single displacement device covering a limited area is shown, it is possible and generally typical to use multiple displacement devices (even up to 30 such devices) at dispersed locations between the first energy absorbing layer 120 and the second energy absorbing layer 160. In other implementations with fewer displacement devices, or even a single displacement device, the displacement device(s) may be much larger in area than the representative displacement device 190. The displacement devices are further described below in more detail.

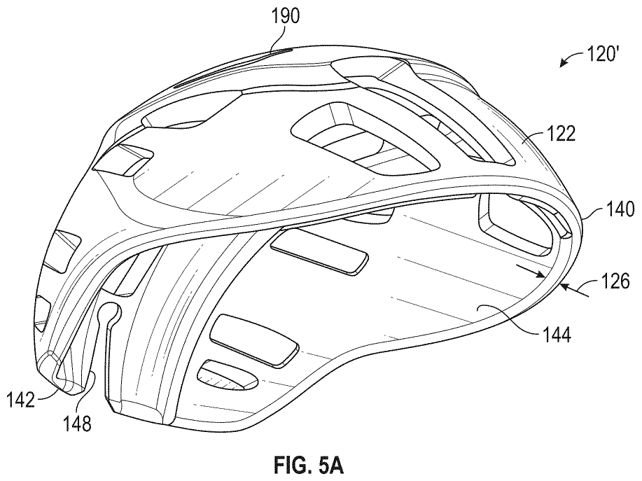

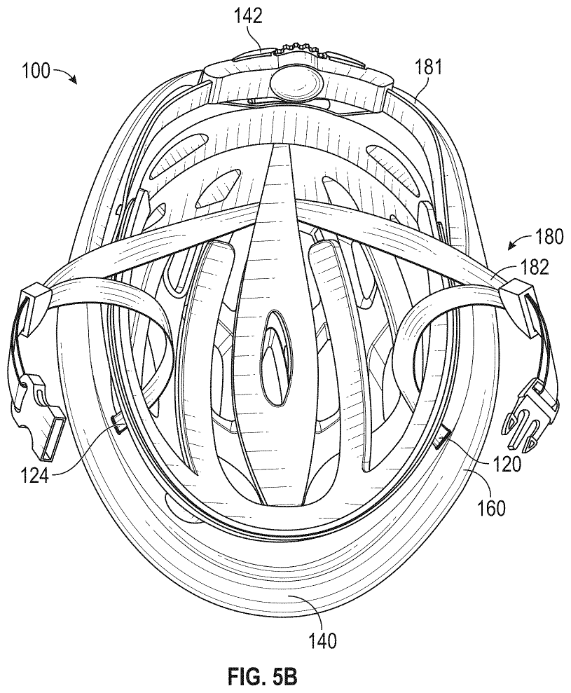

FIG. 5B is a bottom plan view of the assembled helmet 100 showing the cavity for accommodating the wearer's head as defined by the first inner surface 124. As also shown, the helmet 100 is typically provided with a fit system, e.g., such as a fit system 180, for adapting the size and shape of the helmet to the wearer's head. A typical fit system includes an adjustable band 181 or a portion thereof to fit the cavity of the helmet closely to the circumference of the wearer's head and one or more straps 182 to secure the helmet to the wearer's head, such as around the wearer's chin. The straps 182 are secured together by buckle parts 184.

As also described elsewhere herein, the first and second energy absorbing layers may be formed of any suitable materials. In some implementations, the first and second energy absorbing layers are formed of a foamed polymer material, such as an expanded polystyrene (EPS) material. Other shock absorbing materials, such as expanded polypropylene (EPP), vinyl nitrile foam, thermoplastic urethane (TPU) foam and others, could also be used. In some implementations, the first and/or second energy absorbing layers are formed of a plastic material having a hollow geometry designed to produce reliable crush characteristics. In some implementations, such a hollow plastic material is formed using a 3D printing or other similar process. The protective outer shell is preferably formed of a hard plastic, such as polycarbonate, ABS or other suitable plastic.

As shown in FIG. 5B, the first energy absorbing layer 120 has a substantially continuous periphery forming a generally elliptical opening sized to fit over the wearer's head. As described in more detail below, the first energy absorbing layer 120 is designed to be deformed (e.g., crushed, folded, wrapped, etc.) to fit it within the second energy absorbing layer, and then allowed to return to its relaxed, expanded state. The first energy absorbing layer 120 is then retained by one or more features on the inner side of the second energy absorbing layer 160, which can be formed features or attached features.

FIG. 5A is a perspective view of a modified first energy absorbing layer 120′. The modified first energy absorbing layer 120′ has a notch or gap 148 defined along periphery, such as at the rearward end 142. The notch 148 allows the first energy absorbing layer 120′ to be deformed more readily to make installation into the second energy absorbing layer 160 easier.

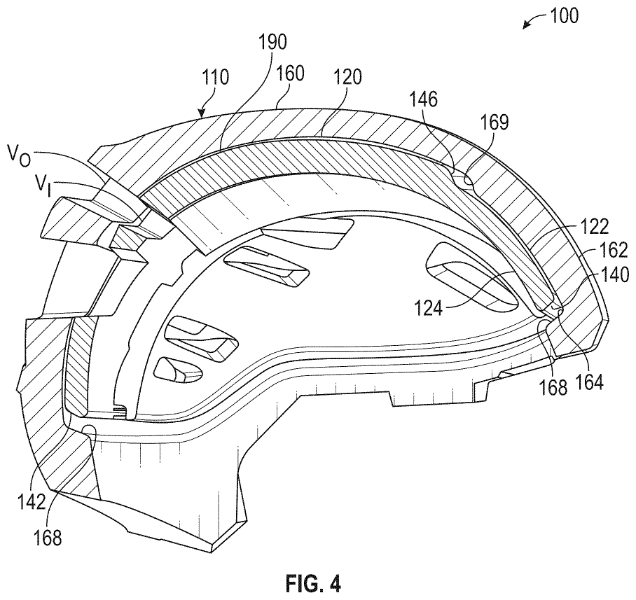

Referring again to FIGS. 2-4, sectioned side elevations of the helmet 100 depict three different positions of the first energy absorbing layer 120 relative to the second energy absorbing layer 160. In FIG. 2, the first energy absorbing layer 120 has rotated forwardly to a full extent, i.e., until the forward end 140 contacts a recessed peripheral edge 168 formed in the second energy absorbing layer 160, as facilitated by the displacement device 190. In FIG. 3, the first energy absorbing layer 120 is shown at its rearmost position in the opposite direction, i.e., the rearward end 142 is in contact with the recessed peripheral edge 168. In FIG. 4, the helmet is shown from its opposite side in a normal position, in which inner vent openings V_{I} in the first energy absorbing layer 120 are aligned with outer vent openings V_{O} in the second energy absorbing layer 160.

In addition, the helmet 100 can have a recess formed in the second energy absorbing layer 160, with a forward surface 169. The first energy absorbing layer 120 can have a correspondingly shaped protrusion (also referred to herein as an external engagement section), or thicker area, fitting within the recess with a facing surface 146 facing the forward surface 169. Thus, the first energy absorbing layer 120 is not limited to having a uniform thickness, but can be designed to have one or more areas having a greater thickness. Additionally, the same range of displacement between the first energy absorbing layer 120 and the second energy absorbing layer 160, as discussed in greater detail below, can still be implemented.

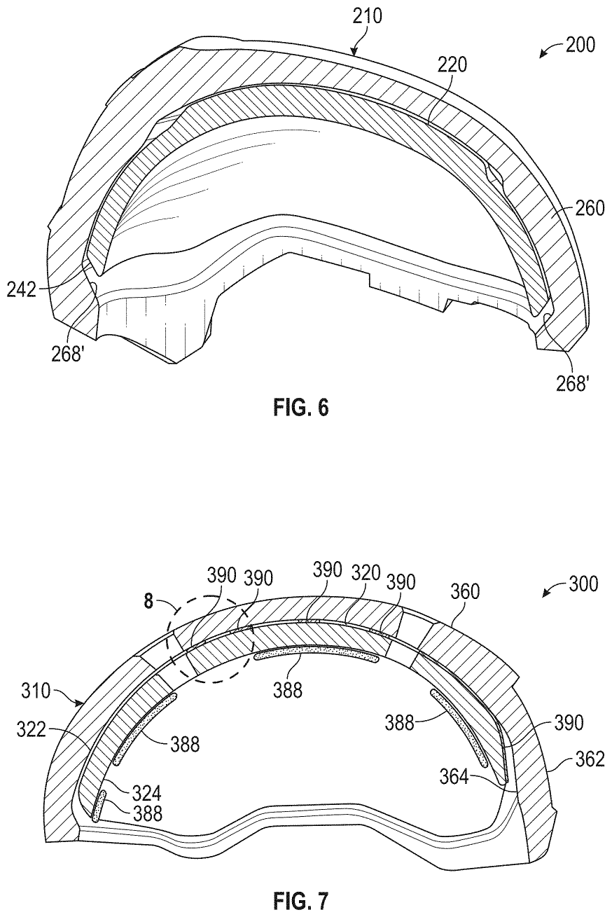

FIG. 6 is a sectioned side elevation view of a helmet 200 according to another implementation. In FIG. 6, components having generally the same description as described above are labelled with the same reference number, plus 100. In the helmet 200, a relieved edge 268′ is provided on the second energy absorbing layer 260 as shown to enable easier installation of the first energy absorbing layer 220 into the second energy absorbing layer 260. Specifically, the edge 268′ is relieved, such as to have a beveled shape as shown or other relieved shape or profile, to provide slightly greater space to manipulate the inner energy absorbing layer 220. In the illustrated implementation, the relieved edge 268′ extends at an entry angle of approximately 45 degrees, but other entry angles of at least 30 degrees could also be used. Similarly, the adjacent surface of the first energy absorbing layer 220, such as is shown for the forward end 240 and the rearward end 242, can be inclined in the same general direction or even parallel to the relieved edge 268′. In addition, providing relieved profiles as shown, e.g., entry angles, rather than the perpendicular surfaces that meet more directly, tends to improve energy absorbing performance during impact because the contact areas are comparatively larger and the stopping of the rotational action occurs more gradually. Furthermore, in perpendicular-to-surface linear impacts, the cross section provided typically enhances energy absorption compared to 90-degree mating surfaces, since the energy-absorbing material can crack less easily, and the impact energy can be absorbed by a greater mass of material.

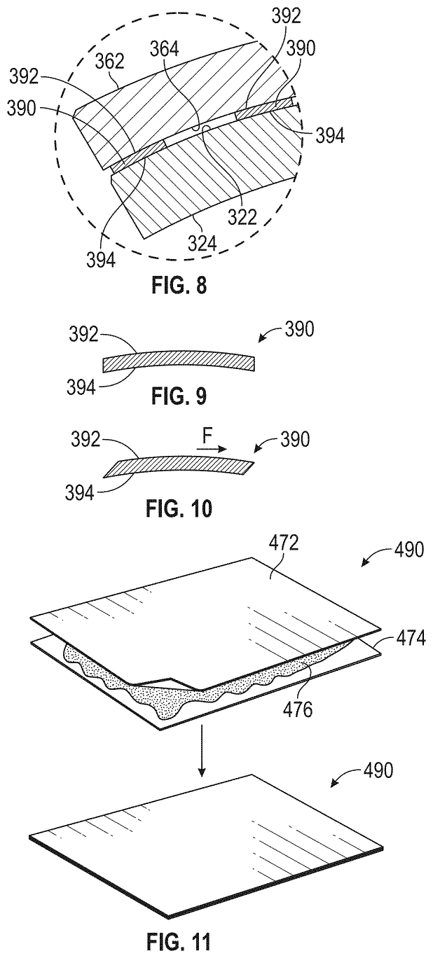

FIG. 7 is a sectioned side elevation of a helmet 300 according to another implementation. In FIG. 7, components having generally the same description as those for the helmet 100 set forth above are labelled with the same reference number, plus 200. As shown in FIG. 7, there are displacement devices 390 provided between the first energy absorbing layer 320 and the second energy absorbing layer 360 at multiple predetermined locations. Although described specifically for the implementation in FIGS. 7 and 8, the displacement devices 390 can be applied to any of the described implementations.

More specifically, and with additional reference to the magnified view shown in FIG. 8, an outer side 392 of each displacement device 390 is affixed to the first outer surface 322, and an opposite inner side 394 of each displacement device 390 is affixed to the second inner surface 364. In some embodiments, the displacement devices 390 are constructed of a silicone gel having predetermined properties selected for the application. For example, the displacement devices 390 can be pieces of silicone gel sheet material having predetermined material properties, such as a Shore 00 durometer of 0 to 60 measured using the Shore 00 scale suited for extra soft materials. Suitable silicone gels include certain silicone gels used in medical treatment of scarred tissue. As one example, a suitable class of silicone gels is available from Wacker (SilGel family 612 and 613, https://www.wacker.com/cms/en/products/brands_3/wacker-silgel/wacker-silgel.jsp). For example, Wacker SilGel 613 is described to have a dynamic viscosity (at 25° C.) of 150 MPa·s (uncured) and a density of 0.97 g/cm³ (at 23° C., cured and uncured). The material is described as having very low viscosity, rapid curing at room temperature, very low hardness, inherent tack and excellent damping properties. Technical data sheet for Wacker SilGel 613, Version 1.1 (date of alteration 21 May 2010), which is incorporated herein by reference.

Additionally, polyurethanes having similar properties to silicone gels arc also suitable materials. For example, Sorbothane(®) material (https://www.sorbothane.com/) is another example of a suitable class of materials. See, e.g., “Data Sheet 101 Material Properties of Sorbothane(®) (effective Jun. 1, 2018),” specifying tensile strength, bulk modulus, density, resilience test rebound height, dynamic Young's modulus and other physical and chemical parameters of Sorbothane® materials, which is incorporated herein by reference.

The displacement devices 390 can be dimensioned to have suitable thicknesses to maintain desired spacings between the first energy absorbing layer 320 and the second energy absorbing layer 360. In some implementations, there is a 1.5 to 3 mm space between the first energy absorbing layer 320 and the second energy absorbing layer 360 at any location, so the displacement devices 390 can be dimensioned to have a corresponding 1.5 to 3 mm thickness as appropriate. In some implementations, the first energy absorbing layer 320 is thus “suspended” within the second energy absorbing layer 360, depending upon the number and positions of the displacement devices 390. Further, the fit and spacing between the first energy absorbing layer 320 and the second energy absorbing layer 360 may provide for at least 5 mm of relative rotational travel.

The displacement devices 390 may be affixed self-adhesively, and/or with an added adhesive, including, e.g., a suitable structural adhesive, pressure-sensitive adhesive or other affixing method, such as a tape (see, e.g., the products described at www.gergonne.com/en/standard-prochicta/gergogil.html). The displacement devices 390 may be spaced apart in a pre-determined pattern over the extent of the helmet. For example, the displacement devices 390 may be positioned to cover at least 10% of the surface areas of the inner cavity.

In the implementation of FIGS. 7 and 8, the inner surface 324 of the first energy absorbing layer 320 includes multiple comfort pads 388 that are dimensioned and positioned to fit the inner cavity of the helmet 300 to the wearer's head. The comfort pads 388 may be permanently or removably attached to the inner surface 324. In some implementations, the comfort pads 388 may incorporate displacement device technology in conjunction with the displacement devices 390 to assist in managing oblique impacts.

FIG. 9 is a schematic diagram of one of the displacement devices 390 shown in isolation at rest (i.e., with no applied force or torque). FIG. 10 is a schematic diagram of the displacement device 390 when subjected to a force or a torque (e.g., a force as indicated by the arrow F or a torsional loading) producing shear stress. Shear stress acts parallel or tangential to the surface of a material. In FIG. 10, the shearing force F is applied to the top surface of the shape while the bottom surface is considered to be held in place, and causing the deformation from the approximate rectangular shape in FIG. 9 to the approximate parallelogram shape in FIG. 10. Thus, the displacement devices 390 are designed to respond to applied forces and torques producing shear stress (within a predetermined range) by undergoing shear strain. The resulting deformation may be elastic deformation, in which case the displacement device returns to the shape of FIG. 9, or it may include permanent deformation or structural failure (e.g., if the forces of an oblique impact are sufficient to overcome the bonding forces between the displacement device and the adjacent surfaces).

The silicone gel and polyurethane materials as described herein are primarily implemented for use in their elastic region, i.e., such that the materials will deform during loading and then return to their original shape when the load is removed. The stress-strain curve for elastic materials, which is a progressively steepening curve, indicates that elastic materials are initially compliant and then become stiffer as the load is increased.

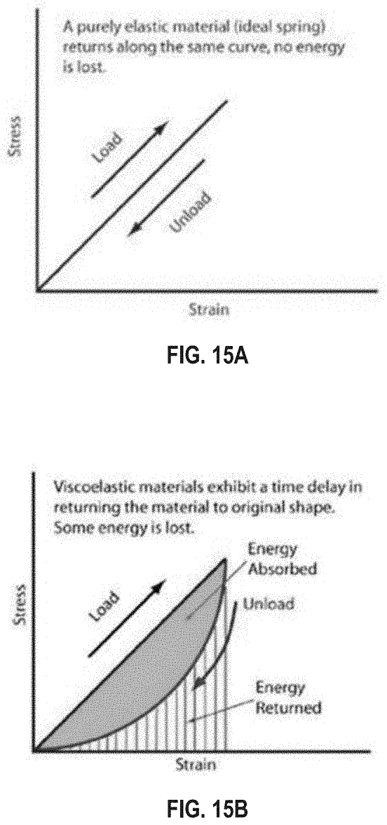

In some implementations, the silicone gel and polyurethane materials may exhibit viscoelastic effects. When an elastic material containing fluid is deformed, the return of the material to its original shape is delayed in time and it is slower to return to its original position. A purely elastic material behaves like an ideal spring with a linear response, and no energy loss as it is loaded and unloaded (see, e.g., FIG. 15A). In contrast, a viscoelastic material exhibits a time delay in returning to its original shape, and some energy is lost (or absorbed) during deformation, such as by way of heat (see, e.g., FIG. 15B). The viscoelastic material exhibits both viscous damping and an elastic response during deformation. The viscoelastic material is modelled by a spring (which models the elastic behavior) in series with a dashpot (which models viscosity).

To the extent that displacement devices absorb energy during deformation, then less energy is available to be transferred to the wearer's head, which is a benefit of such displacement devices over other types that may primarily rely on sliding surfaces.

FIG. 11 is a schematic perspective view of a displacement device 490 according to another implementation, showing it being assembled from components and in an assembled condition. First, a first sheet 472 and a second sheet 474 are assembled on opposite sides of a friction reducing material 476. The friction reducing material may comprise a lubricating substance. Then, the edges of the first sheet 472 and the second sheet 474 are secured together (such as by thermal bonding, adhesive or other suitable technique) so that the friction reducing material 476 is contained within the enclosed space defined by inner surfaces of the sheets 472, 474. The displacement device 470 can then be installed between two objects that are desired to move relative to each other in a predetermined manner with reduced friction and in some cases, added damping and/or allowable displacement. In contrast to the displacement device 390, which can be referred to as a shear component, the displacement device 470 relies on slip planes/a slip system in which parallel surfaces slip or slide past each other. The displacement device 470 on its own tends not to provide any damping or energy absorption, but it may “redirect” applied energy that is not wholly linear.

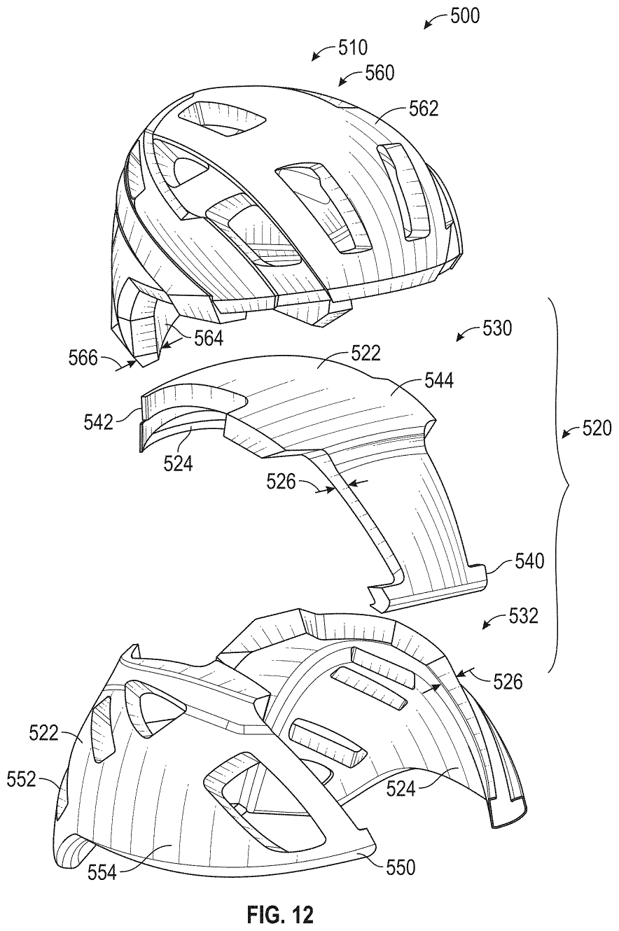

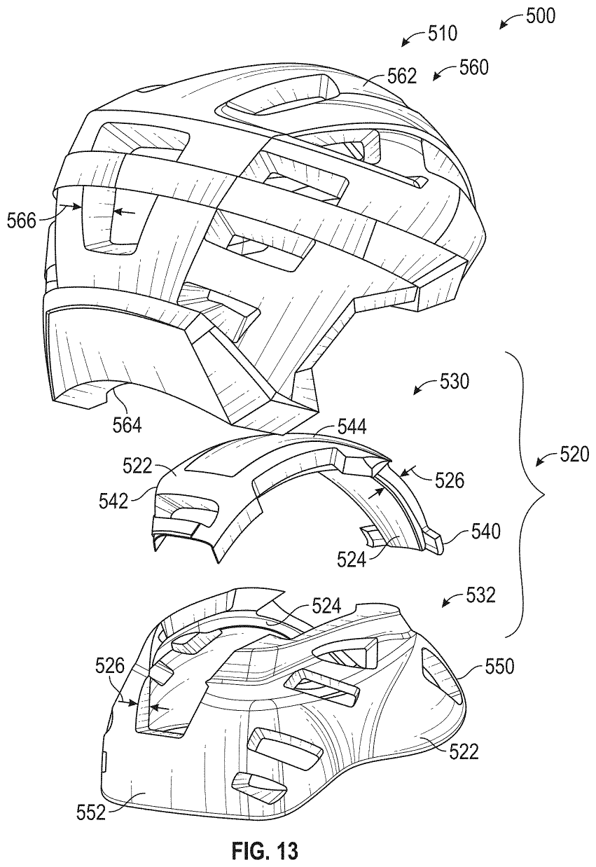

In the above implementations of the helmet, the first energy absorbing layer 120 is formed of a single component. It is also possible for the energy absorbing layers to be formed of multiple components. For example, as shown in FIGS. 12-14, for a helmet 500, the first energy absorbing layer 520 can be formed of a first component 530 and a second component 532. In FIGS. 12-14, components having generally the same description as those for the helmet 100 set forth above are labelled with the same reference number, plus 400.

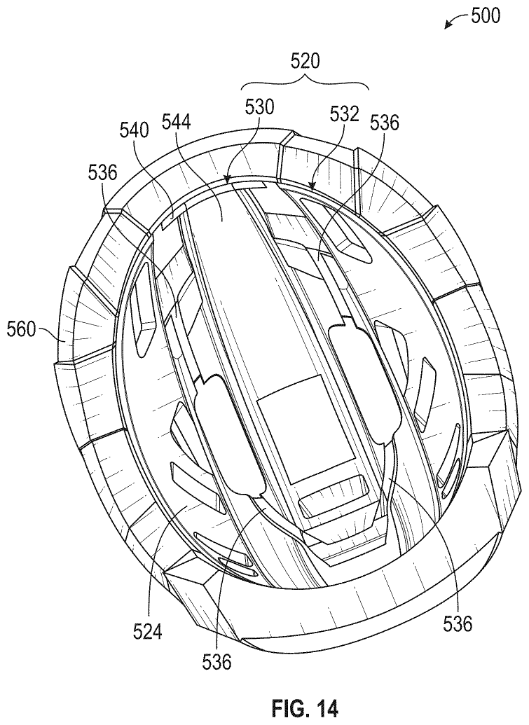

In the illustrated implementation, the first component 530 and the second component 532 are separate pieces, but they could be coupled together, such as with one more pieces of a flexible material. In the illustrated implementation, the first component 530 has a forward end 540, a rearward end 542 and a body 544. The first component 530 is positioned within a recess of the second component 532. As best seen in FIG. 12, the recess of the second component 532 is defined between spaced apart points at a forward end 550 and extends through a body 554 toward a rearward end 552. FIG. 14 is a bottom plan view of the assembled helmet 500 showing the resulting cavity for accommodating the wearer's head as defined by the first inner surface 524 of the first component 530 and the second component 532.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A helmet, comprising:
a protective shell forming an outer surface of the helmet;
a first energy absorbing layer having a first outer surface and a first inner surface, the first inner surface being configured to couple the helmet to a wearer's head;
a second energy absorbing layer having a second outer surface and a second inner surface, the second inner surface facing the first outer surface; and
at least one displacement device positioned between the first energy absorbing layer and the second energy absorbing layer, wherein the displacement device is a shear component having a pair of opposite surfaces configured to be attached to the second inner surface of the second energy absorbing layer and the first outer surface of the first energy absorbing layer, respectively, and
wherein, in response to an oblique impact to the helmet, the shear component undergoes internal shear to allow displacement between the first and second energy absorbing layers producing a damped shear action exhibiting-progressively-greater force in shear without high rebound.

2. (canceled)

3. The helmet of claim 1, wherein the first energy absorbing layer and the second energy absorbing layer are separated from each other at a first location by a thickness of the shear component, and wherein the shear component at the first location has a thickness of 1.5 to 3 mm.

4. The helmet of claim 1, wherein the shear component is formed of a material having a shear modulus of GPa 0.0001 to GPa 0.03.

5. The helmet of claim 1, wherein the shear component: is formed of a material having a Shore 00 durometer of 0 to 60.

6. The helmet of claim 1, wherein the shear component comprises a silicone gel sheet material.

7. (canceled)

8. The helmet of claim 1, wherein the opposite surfaces of the shear component are bonded or adhered to the second inner surface of the second energy absorbing layer and the first outer surface of the first energy absorbing layer, respectively.

9. The helmet of claim 1, wherein the first energy absorbing layer is formed of a deformable material, and wherein the second energy absorbing layer is formed with an opening smaller than the first energy absorbing layer, and wherein the first energy absorbing layer is compressed from its relaxed state and passed through the opening to assemble the first energy absorbing layer within the second energy absorbing layer.

10. The helmet of claim 1, wherein the second energy absorbing layer is formed with a cavity defined to extend from the opening and shaped to accommodate the first energy absorbing layer with a clearance separating the first energy absorbing layer from the second energy absorbing layer.

11. The helmet of claim 1, wherein the first energy absorbing layer and the second energy absorbing layer are separated by 0.25 mm to 1.5 mm at the location of the shear component.

12. A helmet, comprising:
a protective shell forming an outer surface of the helmet,
a first energy absorbing layer having a first outer surface and a first inner surface, the first inner surface being configured to couple the helmet to a wearer's head:
a second energy absorbing layer having a second outer surface and a second inner surface, the second inner surface facing the first outer surface; and
at least one displacement device positioned between the first energy absorbing layer and the second energy absorbing layer,
wherein the at least one displacement device comprises a shear component having a first sheet having a first internal side and a first external side and a second sheet having a second internal side and a second external side, wherein the respective internal sides are positioned to face each other, and wherein the first external side is configured to be attached to the second inner surface of the second energy absorbing layer, and the second external side is configured to be attached to the first outer surface of the first energy absorbing layer
wherein, in response to an oblique impact to the helmet, the shear component undergoes internal shear to allow displacement between the first and second energy absorbing layers.

13. The helmet of claim 12, wherein the first sheet and the second sheet are bonded together at their respective edges.

14. The helmet of claim 12, further comprising a lubricating substance positioned between the first and second internal sides.

15. The helmet of claim 14, wherein at least the first internal side of the first sheet and the second internal side of the second sheet comprise a thermoplastic material, and the lubricating substance comprises a low friction gel.

16. The helmet of claim 12, wherein the first external side of the first sheet and the second external side of the second sheet are bonded or adhered to the second inner surface of the second energy absorbing layer and the first outer surface of the first energy absorbing layer, respectively.

17. The helmet of claim 12, wherein there are multiple displacement devices, and wherein the first energy absorbing layer and the second energy absorbing layer are separated by 1 to 3 mm at least at locations of the multiple displacement devices.

18. The helmet of claim 1, wherein first energy absorbing layer is formed of a deformable material, and wherein the second energy absorbing layer is formed with an opening smaller than the first energy absorbing layer, and wherein the first energy absorbing layer is compressible from its relaxed state into a smaller configuration that can be passed through the opening in the secondary energy absorbing layer to assemble the first energy absorbing layer within the second energy absorbing layer.

19. The helmet of claim 1, wherein the second energy absorbing layer is formed with a cavity defined to extend from the opening and shaped to accommodate the first energy absorbing layer with a clearance separating the first energy absorbing layer from the second energy absorbing layer.

20. The helmet of claim 1, wherein the second energy absorbing layer is formed with a first cavity defined to extend from the opening and shaped to accommodate the first energy absorbing layer with a first clearance separating the first energy absorbing layer from the second energy absorbing layer, further comprising a second cavity formed in the second absorbing layer and an external engagement section protruding from the first energy absorbing layer, wherein the external engagement section is sized to fit within the second cavity with a second clearance.

21. The helmet of claim 1, further comprising a fit system for adapting the helmet to be fitted to the wearer's head, wherein the fit system is coupled to the first energy absorbing layer.

22. The helmet of claim 1, wherein the first and second energy absorbing layers comprise at least one of EPS, EPP, EPO, vinyl nitride, urethane foam, or a plastic material having a hollow geometry designed to produce reliable crush characteristics.

23. The helmet of claim 1, wherein at least one of the first and second energy absorbing layers is made of a plastic material with a hollow geometry by a 3D printing process and designed to produce reliable crush characteristics.

24. The helmet of claim 1, wherein the first energy absorbing layer is shaped to extend over at least about 80% of an inner surface area of the helmet.

25. The helmet of claim 1, wherein the first energy absorbing layer comprises a notch with angled sides, and wherein the notch allows the first absorbing layer to be compressed to a smaller size to facilitate fitting the first energy absorbing layer through the opening in the second energy absorbing layer.

26. (canceled)

27. (canceled)

28. The helmet of claim 1, wherein the shear component is non-sliding.

29. The helmet of claim 1, wherein the shear component consists of a viscoelastic material.

30. The helmet of claim 1, wherein the shear component consists of a thermoplastic material.

31. The helmet of claim 30, wherein the shear component consists of a thermoplastic urethane (TPU) material.

32. The helmet of claim 15, wherein the thermoplastic material consists of a thermoplastic urethane (TPU) material.

33. A helmet, comprising:
a protective shell forming an outer surface of the helmet;
a first energy absorbing layer having a first outer surface and a first inner surface, the first inner surface being configured to couple the helmet to a wearer's head;
a second energy absorbing layer having a second outer surface and a second inner surface, the second inner surface facing the first outer surface; and
at least one displacement device positioned between the first energy absorbing layer and the second energy absorbing layer, wherein the displacement device is a non-sliding shear component having a pair of opposite surfaces configured to be attached to the second inner surface of the second energy absorbing layer and the first outer surface of the first energy absorbing layer, respectively, and
wherein, in response to an oblique impact to the helmet, the shear component undergoes internal shear to allow displacement between the first and second energy absorbing layers producing a damped shear action that absorbs energy.
